(19) United States
(12) Patent Application Publication
(10) Pub. No.: US 2025/0028031 A1
(43) Pub. Date: Jan. 23, 2025

(54) LIDAR DEVICE, METHOD FOR OPERATING THE SAME AND NON- TRANSITORY COMPUTER- READABLE STORAGE MEDIUM STORING PROGRAM FOR PERFORMING THE METHOD

(71) Applicant: HL Klemove Corp., Incheon (KR)

(72) Inventor: Jun Min LEE, Seongnam (KR)

(21) Appl. No.: 18/522,348

(22) Filed: Nov. 29, 2023

(30) Foreign Application Priority Data
Jul. 20, 2023 (KR) 10-2023-0094357

(51) Int. Cl. G01S 7/484; G01S 17/93

(52) U.S. Cl. CPC G01S 7/484; G01S 17/93

(57) ABSTRACT

A LIDAR device is disclosed. The LiDAR according to one embodiment of the present disclosure may include an optical transmitter for transmitting a laser pulse for detection of an external object, an optical receiver for receiving the laser pulse reflected by the external object, and a controller for controlling the optical transmitter and the optical receiver, wherein the controller may determine whether a first condition or a second condition is met, if the first condition is met, the optical transmitter may transmit a duty cycle of the laser pulse at a first duty cycle under control of the controller, and if the second condition is met, the optical transmitter may increase the duty cycle of the laser pulse to a second duty cycle greater than the first duty cycle under the control of the controller and transmit at the second duty cycle.

### CROSS-REFERENCE TO RELATED APPLICATION

This application claims priority to and the benefit of Korean Patent Application No. 10-2023-0094357, filed on Jul. 20, 2023, the disclosure of which is incorporated herein by reference in its entirety.

### FIELD

The present disclosure relates to a LIDAR device, a method for operating the LiDAR device, and a non-transitory computer-readable storage medium storing a program for performing the method, and more particularly, to a LiDAR device installed in a vehicle and recognizing objects disposed in the vicinity of the vehicle while the vehicle is driving, and a method for operating the LiDAR device, and a non-transitory computer-readable storage medium storing a program for performing the method.

### BACKGROUND

Light detection and ranging (LiDAR) is a radar system that measures the distance to the outside using laser pulses. The LiDAR device irradiates laser light to the surrounding area and measures the time it takes for it to reflect outside and return to measure the distance to the outside and the shape of the measurement object.

Recently, the LiDAR device is used in various technical fields such as mobile robots. In particular, the LiDAR device is actively applied to a vehicle for driver assistance and autonomous driving. The LiDAR device installed in the vehicle plays a very important role in recognizing objects existing in the surrounding environment while the vehicle is driving.

If a LIDAR device is installed in a vehicle, it is required to accurately recognize an object disposed relatively far. To this end, it may be considered to increase an output of a laser diode. However, in this case, there may be a problem that the accuracy of detection is lowered as the amount of internal reflection increases. In addition, deterioration and failure of performance may occur due to an increase in the amount of heat generated.

In this situation, it is required to improve the long distance detection capability of the LIDAR device installed in the vehicle. In particular, there is a growing need to develop a technology that may minimize the increase in the output and heat generation of a laser diode while improving the long-distance detection capability of a LIDAR device while the vehicle is driving at high speed.

### SUMMARY

The present disclosure is to solve the problems as above, and the present disclosure provides a LIDAR device in which remote detection capability is improved, a method for operating the LiDAR device, and a non-transitory computer-readable storage medium storing a program for performing the method.

Another object of the present disclosure is to provide a LiDAR device installed in a vehicle, which has improved remote detection capability and minimizes the increase in output and heat generation of the device, a method for operating the LiDAR device, and a non-transitory computer-readable storage medium storing a program for performing the method.

According to an aspect of the present disclosure, there is provided a LIDAR device including: an optical transmitter for transmitting a laser pulse for detection of an external object; an optical receiver for receiving the laser pulse reflected by the external object; and a controller for controlling the optical transmitter and the optical receiver, wherein the controller determines whether a first condition or a second condition is met, if the first condition is met, the optical transmitter transmits a duty cycle of the laser pulse at a first duty cycle under control of the controller, and if the second condition is met, the optical transmitter increases the duty cycle of the laser pulse to a second duty cycle greater than the first duty cycle under the control of the controller and transmits at the second duty cycle.

In the LiDAR device according to an aspect of the present disclosure, the LiDAR device may be installed in a vehicle; and the first condition is that a speed of the vehicle is less than a reference speed, and the second condition is that a speed of the vehicle is equal to or greater than the reference speed.

In the LiDAR device according to an aspect of the present disclosure, the reference speed may be set to be at 50 to 100 km/h.

In the LiDAR device according to an aspect of the present disclosure, the first condition may be that a temperature is equal to or greater than a reference temperature, and the second condition may be that a temperature is less than the reference temperature.

In the LiDAR device according to one aspect of the present disclosure, the reference temperature may be set to be at 15 to 25° C.

In the LIDAR device according to one aspect of the present disclosure, a period of the second duty cycle may be set to be shorter than a period of the first duty cycle.

In the LiDAR device according to an aspect of the present disclosure, a pulse width of the first duty cycle and a pulse width of the second duty cycle are the same, and a period of the second duty cycle is set to be shorter than the period of the first duty cycle.

In the LiDAR device according to an aspect of the present disclosure, a pulse width of the first duty cycle and a pulse width of the second duty cycle may be different, and a period of the second duty cycle may be set to be shorter than a period of the first duty cycle.

In the LiDAR device according to one aspect of the present disclosure, the second duty cycle may be set to 1.5 to 3 times the first duty cycle.

The LiDAR device according to an aspect of the present disclosure may further include a signal processor for processing the laser pulse received by the optical receiver under the control of the controller, and the signal processor may accumulate and process the received laser pulse for a unit time set identically regardless of the first condition and the second condition.

In the LiDAR device according to an aspect of the present disclosure, wherein if the second condition is met, the signal processor may accumulate and process more laser pulses per unit time compared to if the first condition is met.

According to another aspect of the present disclosure, there is provided a method for operating a LIDAR device including an optical transmitter for transmitting a laser pulse for detection of an external object, an optical receiver for receiving the laser pulse reflected by the external object, and a controller for controlling the optical transmitter and the optical receiver, the method including: determining, with the controller, whether a first condition or a second condition is met; if the controller determines that the first condition is met, transmitting, with the optical transmitter, a duty cycle of the laser pulse at a first duty cycle under control of the controller; and if the controller determines that the second condition is met, increasing, with the optical transmitter, the duty cycle of the laser pulse to a second duty cycle greater than the first duty cycle under the control of the controller and transmitting it.

In an operation method of a LIDAR device according to another aspect of the present disclosure, the LiDAR device is installed in a vehicle, and the first condition is that a speed of the vehicle is less than a reference speed, and the second condition is that a speed of the vehicle is equal to or greater than the reference speed.

In the method for operating a LIDAR device according to another aspect of the present disclosure, the reference speed may be set to be at 80 to 100 km/h.

In the method for operating a LIDAR device according to another aspect of the present disclosure, the first condition may be that a temperature is equal to or greater than a reference temperature, and the second condition may be that a temperature is less than the reference temperature.

In the method for operating a LIDAR device according to another aspect of the present disclosure, the reference temperature may be set to be at 15 to 25° C.

In the method for operating a LIDAR device according to another aspect of the present disclosure, a period of the second duty cycle may be set to be shorter than a period of the first duty cycle.

In the method for operating a LIDAR device according to another aspect of the present disclosure, a pulse width of the first duty cycle and a pulse width of the second duty cycle may be the same, and a period of the second duty cycle may be set to be shorter than a period of the first duty cycle.

In the method for operating a LIDAR device according to another aspect of the present disclosure, a pulse width of the first duty cycle and a pulse width of the second duty cycle are different, and a period of the second duty cycle is set to be shorter than a period of the first duty cycle.

In the method for operating a LIDAR device according to another aspect of the present disclosure, the second duty cycle may be set to 1.5 to 3 times the first duty cycle.

In the method for operating a LiDAR device according to another aspect of the present disclosure, the LiDAR device may further include a signal processor for processing the laser pulse received by the optical receiver under the control of the controller, and the method further including: accumulating and processing, with the signal processor, the received laser pulse for a unit time set identically regardless of the first condition and the second condition.

In the method for operating a LIDAR device according to another aspect of the present disclosure, if the second condition is met, the signal processor may accumulate and process more laser pulses per unit time compared to if the first condition is met.

According to another aspect of the present disclosure, there is provided a non-transitory computer-readable storage medium having a program stored thereon including at least one instruction for performing the method for operating the LiDAR device.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a diagram showing the configuration of a LIDAR device according to an embodiment of the present disclosure.

FIG. 2 is a diagram showing a configuration of an optical transmitter of a LIDAR device according to an embodiment of the present disclosure.

FIG. 3 is a diagram showing a configuration of an optical receiver of a LIDAR device according to an embodiment of the present disclosure.

FIG. 4 is a diagram showing an example of a laser pulse transmitted by an optical transmitter of a LIDAR device according to an embodiment of the present in corresponding to a first condition.

FIG. 5 is a diagram showing a laser light transmission period of an optical transmitter of a LIDAR apparatus according to an embodiment of the present disclosure if a first condition is met.

FIG. 6 is a diagram showing an example of a laser pulse transmitted by an optical transmitter of a LIDAR device according to an embodiment of the present disclosure if a second condition is met.

FIG. 7 is a diagram showing a laser light transmission period of an optical transmitter of a LiDAR device according to an embodiment of the present disclosure if a second condition is met.

FIG. 8 is a diagram showing another example of a laser pulse transmitted by an optical transmitter of a LIDAR device according to an embodiment of the present disclosure if a second condition is met.

FIG. 9 is a flowchart for a method of operating a LIDAR device according to an embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used In the specification and the claims are not limitedly construed as their ordinary or dictionary meanings, and should be construed as meaning and concept consistent with the technical spirit of the present disclosure in accordance with the principle that the inventors can define terms and concepts in order to best describe their invention.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

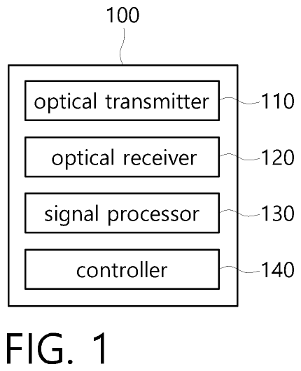

FIG. 1 is a diagram showing the configuration of a LIDAR device according to an embodiment of the present disclosure.

The LiDAR device 100 according to an embodiment of the present disclosure transmits laser light to the outside and receives the laser light reflected by an external object and returned. In addition, the LiDAR device 100 may detect the received laser light to calculate a distance to the object. In this case, the laser light may be transmitted in the form of a laser pulse. For example, the LiDAR device 100 according to an embodiment of the present disclosure may be a flash LiDAR.

The LiDAR device 100 according to an embodiment of the present disclosure may be installed in a vehicle. More specifically, the LiDAR device 100 may be installed in the vehicle and recognize obstacles existing in the vicinity of the vehicle while the vehicle is driving. In addition, the LiDAR device 100 may operate in connection with an advanced driver assistance system (ADAS), an autonomous driving system, or the like of the vehicle.

Referring to FIG. 1, the LiDAR device 100 according to an embodiment of the present disclosure may include an optical transmitter 110, an optical receiver 120, a signal processor 130, and a controller 140.

The optical transmitter 110 transmits laser light for detection of an external object. More specifically, the optical transmitter 110 may transmit the laser pulse to the outside.

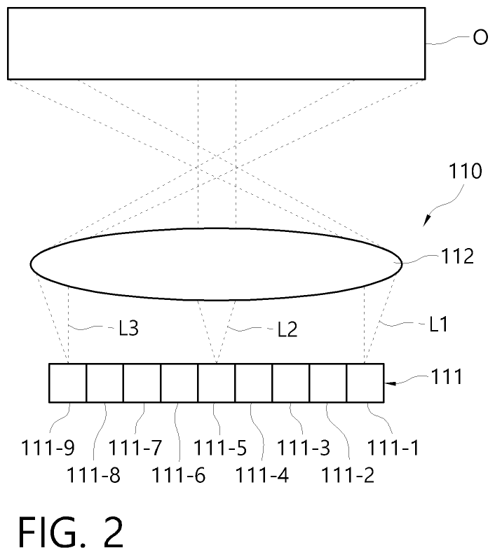

FIG. 2 is a diagram showing a configuration of an optical transmitter of a LIDAR device according to an embodiment of the present disclosure.

Referring to FIG. 2, the optical transmitter 110 may include a light source 111 for generating the laser light and a transmission optical system 112 for aligning the laser light generated by the light source 111.

The light source 111 may include one or more laser elements 111-1, 111-2, 111-3, 111-4, 111-5, 111-6, 111-7, 111-8, and 111-9. For example, the laser element may be a laser diode. The number of laser elements shown in FIG. 2 is exemplary, and the number of laser elements may be increased or decreased as necessary.

In an embodiment of the present disclosure, individual laser elements included in the light source 111 may operate sequentially. In addition, one laser element may transmit a laser pulse at one transmission period. As described below, one transmission period may be changed in engagement with a change in duty cycle.

The transmission optical system 112 guides the traveling direction of the laser pulse transmitted from the light source 111. The transmission optical system 112 may include a lens. For example, the lens may be a cylindrical lens, an acylindrical lens, a spherical lens, or an aspherical lens. The transmission optical system 112 may also include a micro lens array.

Referring to FIG. 2, the laser pulse L1 transmitted from the laser element 111-1 disposed at the rightmost side of the light source 111 may be refracted to the left side after passing through the transmission optical system 112 and proceed toward the external object O. In addition, the laser pulse L2 transmitted from the laser element 111-5 disposed at the center of the light source 111 may be incident vertically to the transmission optical system 112 and go straight toward the external object O. In addition, the laser pulse L3 transmitted from the laser element 111-9 disposed at the leftmost side of the light source 111 may be refracted to the right side after passing through the transmission optical system 112 and proceed toward the external object O.

The optical receiver 120 receives the laser light reflected from the external object. More specifically, the optical receiver 120 may receive the laser pulse transmitted to the outside by the optical transmitter 110 and reflected from the external object. The laser light reflected by the external object and returned may have a received waveform corresponding to the laser pulse transmitted as an echo in which the transmitted laser pulse is reflected.

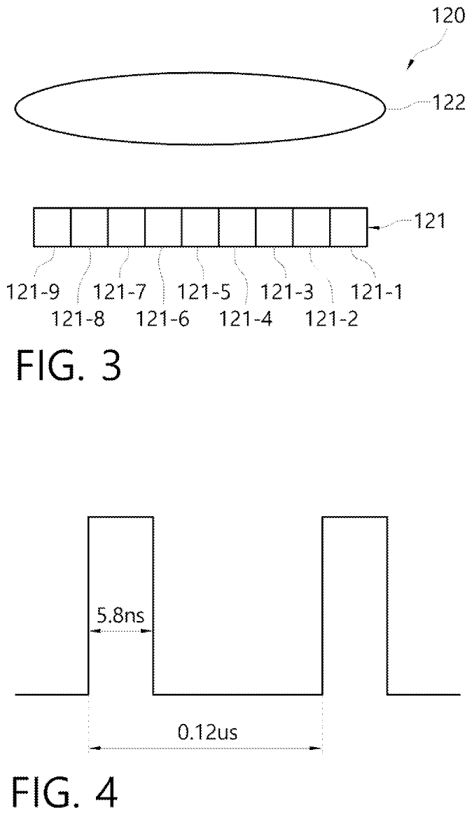

FIG. 3 is a diagram showing a detailed configuration of an optical receiver of a LIDAR device according to an embodiment of the present disclosure.

Referring to FIG. 3, the optical receiver 120 may include an optical sensor 121 that receives the laser light reflected and returned to the LiDAR device 100 and a reception optical system 122 that is disposed on a receiving path of the laser light and guides the laser light traveling to the optical sensor 121.

The optical sensor 121 may include one or more detectors 121-1, 121-2, 121-3, 121-4, 121-5, 121-6, 121-7, 121-8, 121-9. Of course, the number of detectors shown in FIG. 3 is exemplary, and the number of detectors may be increased or decreased as necessary.

In an embodiment of the present disclosure, a plurality of detectors 121-1, 121-2, 121-3, 121-4, 121-5, 121-6, 121-7, 121-8, 121-9 included in the optical sensor 121 may operate sequentially. In addition, one detector may operate at one reception period. In this case, one reception period may have a length corresponding to one transmission period.

The reception optical system 122 guides the traveling direction of the laser pulse incident to the LiDAR device 100. The reception optical system 122 may include at least one of a lens and a micro lens array. For example, the lens may be a cylindrical lens, a non-cylindrical lens, a spherical lens, or an aspherical lens.

The signal processor 130 processes the laser pulse received by the optical receiver 120. The signal processor 130 may accumulate and process the laser pulse received by the optical sensor 121 of the optical receiver 120 for a predetermined unit time. An external object may be recognized by a signal processed by the signal processor 130, and a distance to the external object may be determined.

The controller 140 controls the optical transmitter 110, the optical receiver 120, and the signal processor 130. In an embodiment of the present disclosure, the controller 140 may control the light source 111 of the optical transmitter 110, the optical sensor 121 of the optical receiver 120, and the signal processor 130.

More specifically, the controller 140 may control on/off one or more laser elements 111-1, 111-2, 111-3, 111-4, 111-5, 111-6, 111-7, 111-8, 111-9b of the light source 111. In addition, the controller 140 may individually control the detectors 121-1, 121-2, 121-3, 121-4, 121-5, 121-6, 121-7, 121-9b of the optical sensor 121.

In an embodiment of the present disclosure, the controller 140 determines whether a predetermined condition is met according to a preset criterion, and may variably set the duty cycle of the laser pulse transmitted by the optical transmitter 110 depending on the condition. More specifically, the controller 140 may change the duty cycle of the laser pulse transmitted by the optical transmitter 110 according to the condition.

Here, the duty cycle is a numerical value representing a percentage of the time at time the signal is turned on in one period of the signal. In detail, the duty cycle may be defined as the time during which the laser light source is turned on for one transmission period when the optical transmitter 110 transmits the laser pulse.

The controller 140 may determine whether a first condition or a second condition is met. The controller 140 may control the optical transmitter 110 to transmit a laser pulse at the first duty cycle if the first condition is met, and control the optical transmitter 110 to transmit the laser pulse at a second duty cycle greater than the first duty cycle if the second condition is met.

Here, the first condition may mean a situation in which an adjustment of the amount of heat generated by the optical transmitter 110 is relatively more important than an accuracy and speed of recognition of the external object. In addition, the second condition may mean a situation in which the accuracy and speed of recognition of the external object are relatively more important than the adjustment of the amount of heat generated by the optical transmitter 110.

When the LiDAR device 100 is installed and used in the vehicle, the first condition and the second condition may be determined based on a driving speed of the vehicle. The vehicle may travel less than a reference speed based on the reference speed, or may travel equal to or greater than the reference speed. At this time, the former may be the first condition (low-speed driving condition) and the latter may be the second condition (high-speed driving condition).

In other words, the first condition may be that the speed of the vehicle is less than the reference speed, and the second condition may be that the speed of the vehicle is equal to or greater than the reference speed. For example, the reference speed may be set to be at 50 to 100 km/h. As a more specific example, the reference speed may be 80 km/h.

If the vehicle is driving at the low-speed, the distance between the object disposed remotely and the vehicle becomes closer relatively slowly. Accordingly, in the first condition, reduction in the amount of heat generated by the optical transmitter 110 may be more important than the accuracy and speed of detection for the object disposed remotely.

If the vehicle is traveling at the high-speed, the distance between the object placed remotely and the vehicle becomes relatively fast. Accordingly, in the second condition, the accuracy and speed of detection for the object disposed remotely may be more important than the reduction in the amount of heat of the optical transmitter.

At this time, the controller 140 needs speed information of the vehicle to determine whether the first condition or the second condition is met. In this regard, the LiDAR device 100 may receive vehicle speed information from an ECU of the vehicle or the like. On the other hand, it may be considered that the LiDAR device 100 additionally includes a speed sensor (not shown).

Meanwhile, in an embodiment of the present disclosure, the first condition and the second condition may be determined based on the temperature around the LIDAR device 100. In other words, the first condition may be that the temperature is equal to or higher than the reference temperature, and the second condition may be that the temperature is less than the reference temperature. For example, the reference temperature may be set to be at 15 to 25° C. As a more detailed example, the reference temperature may be 20° C.

When the first condition and the second condition are set as described above, the first condition may be a condition in which the efficiency of heat dissipation is relatively low when the LiDAR device 100 is heated, and the second condition may be regarded as a condition in which heat dissipation may be smoothly performed when the LiDAR device 100 is heated. In other words, it may be regarded as a situation in which the second condition has a higher heat dissipation efficiency than the first condition.

In this case, in order for the controller 140 to determine whether the first condition or the second condition is met, ambient temperature information is required. In this regard, the LiDAR device 100 may include a temperature sensor (not shown). Meanwhile, it may also be considered to receive temperature information from a temperature sensor (not shown) installed in the vehicle.

If the first condition is met, the controller 140 may control the optical transmitter 110 to transmit a duty cycle of the laser pulse at a first duty cycle. Accordingly, the optical transmitter 110 transmits the duty cycle of the laser pulse as the first duty cycle.

In addition, if the second condition is met, the controller 140 may control the optical transmitter 110 to transmit a duty cycle of the laser pulse at a second duty cycle that is greater than the first duty cycle. Accordingly, the optical transmitter 110 may increase the duty cycle of the laser pulse to the second duty cycle greater than the first duty cycle and transmit the laser pulse as the second duty cycle.

The controller 140 may include one or more processors for calculation. The processor may include one or more IC chips. In addition, the controller 140 may include a storage medium for storage. For example, the storage medium may be random access memory (RAM), flash memory, or the like. In addition, the light source controller 140 may include a circuit board on which one or more processors, storage media, and the like are disposed.

Hereinafter, the operation of the LiDAR device 100 according to an embodiment of the present disclosure will be described in detail.

The controller 140 determines whether the first condition or the second condition is met. As described above, the first condition may mean that the speed of the vehicle is less than the reference speed. In other words, the first condition may be a case in which the vehicle is traveling at a low-speed. In addition, the first condition may be the case in which the ambient temperature of the LiDAR device 100 is equal to or greater than the reference temperature.

If the first condition is met, the optical transmitter 110 transmits the duty cycle of the laser pulse as the first duty cycle under the control of the controller 140. The first duty cycle is set to be smaller than the second duty cycle.

FIG. 4 is a diagram showing an example of a laser pulse transmitted by an optical transmitter of a LIDAR device according to an embodiment of the present in corresponding to a first condition.

Referring to FIG. 4, under the first condition, one signal period may be 0.12 μs, and the pulse width of the laser pulse within one signal period may be 5.8 ns (in FIG. 4, the length of one signal period and the width of the laser pulse are not shown at a ratio corresponding to the length of time). In this case, the first duty cycle is 0.048%.

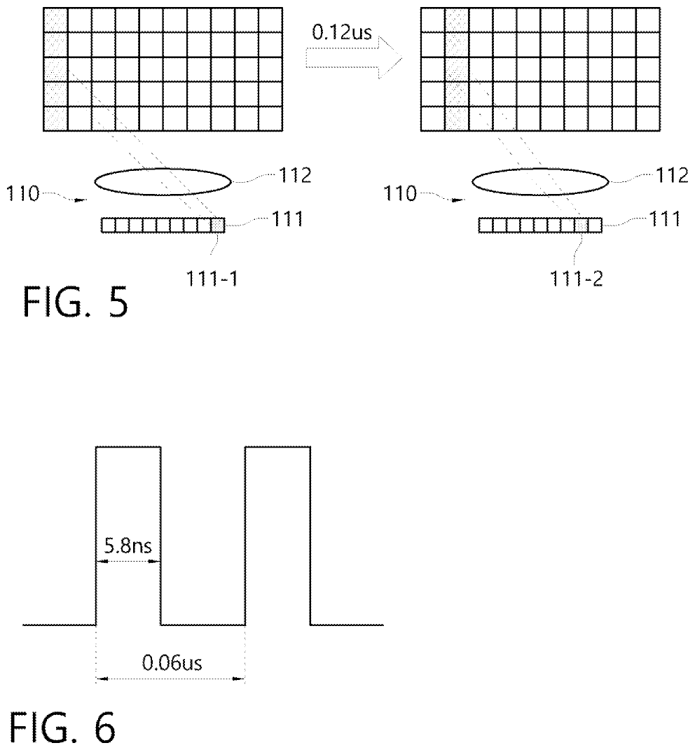

FIG. 5 is a diagram showing a laser light transmission period of an optical transmitter of a LiDAR apparatus according to an embodiment of the present disclosure if a first condition is met.

Referring to FIG. 5, if the first condition is met, a plurality of laser elements 111-1, 111-2, 111-3, 111-4, 111-5, 111-6, 111-7, 111-8, 111-9 included in the light source 111 operate sequentially at intervals of 0.12 μs, which is one signal period. For example, the laser element 111-1 disposed at the rightmost side of the light source 111 may transmit a laser pulse having a pulse width of 5.8 ns during a period of 0.12 μs, and then the laser element 111-2 adjacent to the left side may operate.

The first condition may mean a state in which the need for quick and accurate recognition of an external object, especially obstacles existing remotely, is relatively low. Alternatively, the first condition may mean a state in which an efficiency of heat dissipation is relatively low, and thus suppressing the amount of heat generation is important.

If this first condition is met, the optical transmitter 110 transmits a laser pulse with a relatively small first duty cycle under the control of the controller 140. Accordingly, the amount of heat generation is suppressed and detection of external objects may be performed. That is, the heat generated from the light source 111 of the optical transmitter 110 may be reduced and a problem such as a failure caused by the heat generation may be prevented.

If the second condition is met, the optical transmitter 110 may transmit the duty cycle of the laser pulse with a second duty cycle greater than the first duty cycle under the control of the controller 140. For example, the second duty cycle may be set to 1.5 to 3 times the first duty cycle.

As described above, the second condition may mean that the speed of the vehicle is equal to or greater than the reference speed. In other words, the second condition may be a case in which the vehicle is traveling at a high-speed. In addition, the second condition may be the case in which the ambient temperature of the LiDAR device 100 is less than the reference temperature.

In one embodiment of the present disclosure, the period of the second duty cycle may be set to be shorter than the period of the first duty cycle. More specifically, the pulse width of the first duty cycle and the pulse width of the second duty cycle may be the same, and the period of the second duty cycle may be set to be shorter than that of the first duty cycle.

FIG. 6 is a diagram showing an example of a laser pulse transmitted by an optical transmitter of a LIDAR device according to an embodiment of the present disclosure if a second condition is met.

Referring to FIG. 6, under the second condition, one signal period may be 0.06 μs, and the pulse width of the laser pulse within one signal period may be 5.8 ns (in FIG. 6, the length of one signal period and the width of the laser pulse are not shown at a ratio corresponding to the length of time). In this case, the second duty cycle is 0.1%. In other words, the second duty cycle is set to twice the first duty cycle shown in FIGS. 4 and 5.

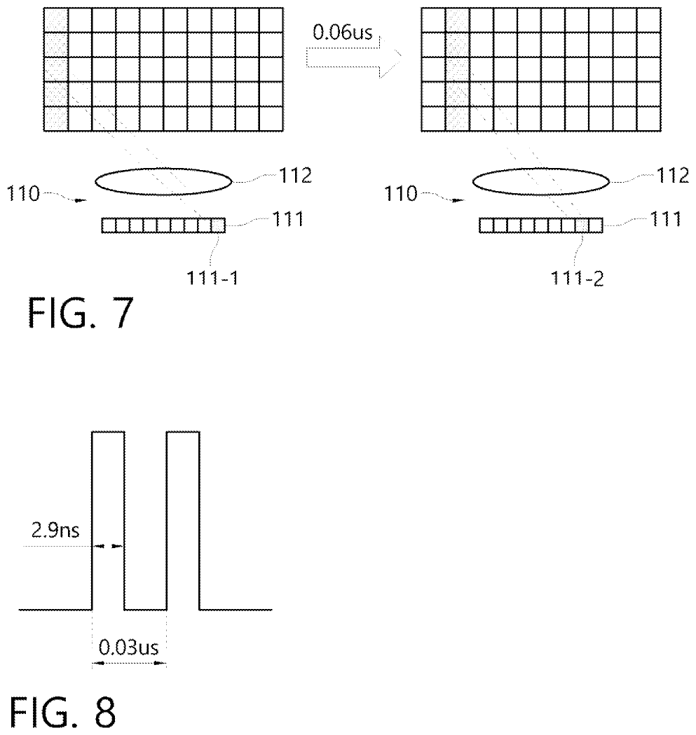

FIG. 7 is a diagram showing a laser light transmission period of an optical transmitter of a LiDAR device according to an embodiment of the present disclosure if a second condition is met.

Referring to FIG. 7, if the second condition is met, a plurality of laser elements 111-1, 111-2, 111-3, 111-4, 111-5, 111-6, 111-7, 111-8, 111-9 included in the light source 111 operate sequentially at intervals of 0.06 μs, which is the signal period. For example, the laser element 111-1 disposed at the rightmost side of the light source 111 may transmit a laser pulse having a pulse width of 5.8 ns during a period of 0.06 μs, and then the laser element 111-2 adjacent to the left side may operate.

Meanwhile, the pulse width of the first duty cycle and the pulse width of the second duty cycle may be different, and the period of the second duty cycle may be set to be shorter than the period of the first duty cycle. For example, the optical transmitter 110 may set one period in the second condition to be 25% shorter than one period in the first condition, and the pulse width in the second condition may be set to be 50% of the pulse width in the first condition. Even if the length and the pulse width of one period are adjusted as described above, the second duty cycle may be set to be larger than the first duty cycle.

FIG. 8 is a diagram showing another example of a laser pulse transmitted by an optical transmitter of a LIDAR device according to an embodiment of the present disclosure if a second condition is met.

Referring to FIG. 8, under the second condition, one signal period may be 0.03 μs, and the pulse width of the laser pulse within one signal period may be 2.9 ns (in FIG. 8, the length of one signal period and the width of the laser pulse are not shown at a ratio corresponding to the length of time). In this case, the second duty cycle is 0.1%. In other words, the second duty cycle is set to twice the first duty cycle shown in FIGS. 4 and 5.

The second condition may mean a state in which the need for quick and accurate recognition of an external object, especially obstacles existing remotely, is relatively large. Alternatively, the second condition may mean a state in which an efficiency of heat dissipation is relatively high.

If the second condition is met, the optical transmitter 110 transmits the laser pulse with the second duty cycle set relatively large according to the control of the controller 140. Accordingly, the recognition of the obstacles disposed remotely may be quick and accurately performed.

As described above, when the optical transmitter 110 transmits the laser pulse by increasing the duty cycle according to the control of the controller 140 in the second condition, the accumulation number of laser pulses received by the optical receiver 120 during the same time may be increased compared to the case of the first condition. Accordingly, the accuracy and the speed of the recognition of the external object O may be increased.

Meanwhile, if the optical transmitter 110 transmits a laser pulse with the second duty cycle set relatively larger than the first duty cycle, the heating amount of the optical transmitter 110 may be increased compared to the case of the optical transmitter 110 transmitting a laser pulse with the first duty cycle relatively smaller than the second duty cycle. This is because the time when the laser element of the light source 111 included in the optical transmitter 110 is turned on is increased.

However, according to the present disclosure, the controller 140 variably sets the duty cycle of the laser pulses transmitted by the optical transmitter 110 depending on the conditions (situations). Through this, it is possible to appropriately balance the improvement in accuracy and speed of detection with the control of the heat generation amount of the optical transmitter 110.

In some more details, the controller 140 reduces the duty cycle of the laser pulses in a situation in which the accuracy and speed of the recognition of the external object O are relatively important. Meanwhile, the controller 140 decreases the duty cycle of the laser pulse in a situation in which the accuracy and speed of the recognition of the external object O are relatively less important. Through this operation, it is possible to harmonize the accuracy and speed improvement of detection, which are a trade-off relationship, with the control of the heat generation amount of the optical transmitter 110.

Meanwhile, in relation to the operation of variably adjusting the duty cycle of the laser pulse transmitted by the optical transmitter 110, the controller 140 may maintain a signal processing unit time of the signal processor 130 constantly.

In more detail, the signal processor 130 may accumulate and process the received laser pulse for a unit time set identically regardless of the first condition and the second condition. That is, the signal processor 130 may constantly maintain the unit time of signal processing for accumulating and processing the laser pulse regardless of the conditions.

Accordingly, if the second condition is met, the signal processor 130 may accumulate and process more laser pulses per unit time compared to if the first condition is met. Therefore, if the second condition is met, the accuracy and speed of recognition of objects disposed outside the LiDAR device 100 may be increased.

Hereinafter, a method for operating a LIDAR device according to an embodiment of the present disclosure will be described.

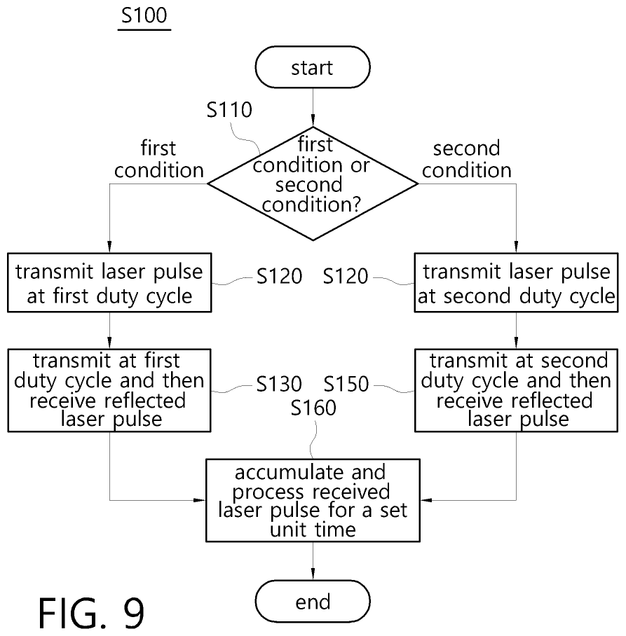

FIG. 9 is a flowchart for a method of operating a LIDAR device according to an embodiment of the present disclosure.

The method for operating a LIDAR device according to an embodiment of the present disclosure is to operate the LiDAR device including an optical transmitter for transmitting a laser pulse for detecting an external object and an optical receiver that receives the laser pulse reflected by the external object. The operation method of a LIDAR device according to an embodiment of the present disclosure may be for operating the LiDAR device 100 according to an embodiment of the present disclosure.

At this time, the LiDAR device 100 may be installed in a vehicle. In more detail, the LiDAR device 100 may be installed in the vehicle and recognize obstacles existing in the vicinity of the vehicle while the vehicle is driving. In addition, the LiDAR device 100 may operate in connection with an advanced driver assistance system (ADAS), an autonomous driving system, or the like of the vehicle.

Hereinafter, a method for operating a LIDAR device according to an embodiment of the present disclosure will be described in detail with reference to FIG. 9.

First, the controller 140 determines whether a first condition or a second condition is met (S110).

The first condition may mean a situation in which an adjustment of the amount of heat generated by the optical transmitter 110 is relatively more important than an accuracy and speed of recognition of the external object. In addition, the first condition may mean a state in which an efficiency of a heat dissipation of the optical transmitter 110 is relatively high.

The second condition may mean a situation in which the accuracy and speed of recognition of the external object are relatively more important than the adjustment of the amount of heat generated by the optical transmitter 110. In addition, the second condition may mean a state in which the efficiency of a heat dissipation of the optical transmitter 110 is relatively low.

As described above, assuming that the LiDAR device 100 according to an embodiment of the present disclosure is used for detecting a surrounding object during driving of the vehicle while installed in the vehicle, the first condition may be set to have a speed of the vehicle being less than a reference speed, and the second condition may be set to have a speed of the vehicle being equal to or greater than the reference speed. For example, the reference speed may be set to be at 50 to 100 km/h. As a more specific example, the reference speed may be 80 km/h.

Meanwhile, the first condition may be that the temperature is equal to or higher than the reference temperature, and the second condition may be that the temperature is less than the reference temperature. For example, the reference temperature may be set to be at 15 to 25° C. As a more detailed example, the reference temperature may be 20° C.

Next, if it is determined that the first condition is met, the optical transmitter 110 transmits the duty cycle of the laser pulse as the first duty cycle under the control of the controller 140 (S120).

For example, under the first condition, one signal period may be 0.12 μs, and the pulse width of the laser pulse within one signal period may be 5.8 ns. In this case, the first duty cycle may be 0.048%. In other words, the optical transmitter 110 may transmit the laser pulse with a transmission period of 0.12 μs and at a duty cycle of 0.048%.

Next, the optical receiver 120 receives the laser pulse transmitted at the first duty cycle and then reflected by an external object and returned (S130).

In this case, the optical receiver 120 may receive the laser pulse with a reception period corresponding to the transmission period. The optical receiver 120 may receive the laser pulse under the control of the controller 140. In addition, the laser pulse received by the optical receiver 120 may be processed by the signal processor 130.

Meanwhile, if it is determined that the second condition is met, the optical transmitter 110 increases the duty cycle of the laser pulse to a second duty cycle greater than the first duty cycle under the control of the controller 140 and transmits the laser pulse (S140).

In an embodiment of the present disclosure, the period of the second duty cycle may be set to be shorter than the period of the first duty cycle. More specifically, the pulse width of the first duty cycle and the pulse width of the second duty cycle may be the same, and the period of the second duty cycle may be set to be shorter than the period of the first duty cycle.

For example, under the second condition, one signal period may be 0.06 μs, and the pulse width of the laser pulse within one signal period may be 5.8 ns. In this case, the second duty cycle may be 0.1%. In other words, the second duty cycle may be twice the first duty cycle.

Meanwhile, the pulse width of the first duty cycle and the pulse width of the second duty cycle may be different, and the period of the second duty cycle may be set to be shorter than the period of the first duty cycle. For example, the optical transmitter 110 may set one period in the second condition to be 25% shorter than one period in the first condition, and the pulse width in the second condition may be set to be 50% of the pulse width in the first condition. Even if the length and the pulse width of one period are adjusted as described above, the second duty cycle may be increased than the first duty cycle.

As a specific example, under the second condition, one signal period may be 0.03 μs, and the pulse width of the laser pulse within one signal period may be 2.9 ns. In this, the second duty cycle may be 0.1%. In other words, the second duty cycle may be twice the first duty cycle.

The second duty cycle may be set to 1.5 to 3 times the first duty cycle. That is, in the case of the second condition, the optical transmitter 110 may transmit the laser pulse with the second duty cycle set to 1.5 to 3 times the first duty cycle.

Next, the optical receiver 120 receives the laser pulse transmitted at the second duty cycle and then reflected by an external object and returned (S150).

In this case, the optical receiver 120 may receive a laser pulse with a reception period corresponding to a transmission period. The optical receiver 120 may receive a laser pulse under the control of the controller 140. The laser pulse received by the optical receiver 120 may be processed by the signal processor 130.

Finally, the signal processor 130 accumulates and processes the received laser pulse for a unit time set identically regardless of the first condition and the second condition (S160).

The signal processor 130 may accumulate and process the laser pulse received by the optical receiver 120. In more detail, the signal processor 130 may accumulate and process the laser pulse received by the optical receiver 120 in a constantly set time unit. The signal processor 130 may be controlled by the controller 140.

If the signal processor 130 accumulates and processes the received laser pulse for a unit time set identically regardless of the conditions, the signal processor 130 may accumulate and process more laser pulses for the unit time in the second condition compared to the first condition. Accordingly, the accuracy and speed of recognition of objects can be improved. In particular, the detection performance for objects disposed remotely may be increased.

Meanwhile, the present disclosure provides a non-transitory computer readable storage medium having a program stored thereon including at least one instruction for performing the method of operating the LiDAR device according to an embodiment of the present disclosure. In this case, the instruction may include not only machine code generated by a compiler but also high-level language code executable by a computer.

The recording media includes hard disks, magnetic media such as floppy disks, and magnetic tapes, optical media such as Compact Disk Read Only Memory (CD-ROMs), and Digital Video Disks (DVDs), magneto-Optical Media, such as a Floptical Disk, hardware devices configured to store and perform program instructions, such as ROM, RAM, flash memory, etc.

According to the above configuration, the LiDAR device, the method for operating the LiDAR device, and the non-transitory computer-readable storage medium storing a program for performing the method according to one aspect of the present disclosure may improve the long-distance detection capability of the LiDAR device by increasing the duty cycle of the laser pulse transmitted by the optical transmitter.

In addition, the LiDAR device, the method for operating the LiDAR device, and the non-transitory computer-readable storage medium storing a program for performing the method according to one aspect of the present disclosure may increase the duty cycle of the laser pulse transmitted by the optical transmitter only if a predetermined condition is met, thereby minimizing the increase in the output and heat generation of a laser diode while improving the long-distance detection capability of a LIDAR device according to the situation.

It should be understood that the effects of the present disclosure are not limited to the above-described effects and include all effects, inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A device for operating a LiDAR device, the device comprising:
an optical transmitter for transmitting a laser pulse for detection of an external object;
an optical receiver for receiving the laser pulse reflected by the external object; and
a controller for controlling the optical transmitter and the optical receiver,
wherein the controller determines whether a first condition or a second condition is met,
if the first condition is met, the optical transmitter transmits a duty cycle of the laser pulse at a first duty cycle under control of the controller, and
if the second condition is met, the optical transmitter increases the duty cycle of the laser pulse to a second duty cycle greater than the first duty cycle under the control of the controller and transmits at the second duty cycle.

2. The LiDAR device of claim 1, wherein the LiDAR device is installed in a vehicle; and
the first condition is that a speed of the vehicle is less than a reference speed, and
the second condition is that a speed of the vehicle is equal to or greater than the reference speed.

3. The LiDAR device of claim 2, wherein the reference speed is set to be at 50 to 100 km/h.

4. The LiDAR device of claim 1, wherein the first condition is that a temperature is equal to or greater than a reference temperature, and
the second condition is that a temperature is less than the reference temperature.

5. The LiDAR device of claim 4, wherein the reference temperature is set to be at 15 to 25° C.

6. The LiDAR device of claim 1, wherein a period of the second duty cycle is set to be shorter than a period of the first duty cycle.

7. The LiDAR device of claim 1, wherein a pulse width of the first duty cycle and a pulse width of the second duty cycle are the same, and
a period of the second duty cycle is set to be shorter than a period of the first duty cycle.

8. The LiDAR device of claim 1, wherein a pulse width of the first duty cycle and a pulse width of the second duty cycle are different, and
a period of the second duty cycle is set to be shorter than a period of the first duty cycle.

9. The LiDAR device of claim 1, wherein the second duty cycle is set to 1.5 to 3 times the first duty cycle.

10. The LiDAR device of claim 1, further comprising:
a signal processor for processing the laser pulse received by the optical receiver under the control of the controller; and
the signal processor accumulates and processes the received laser pulse for a unit time set identically regardless of the first condition and the second condition.

11. The LiDAR device of claim 10, wherein if the second condition is met, the signal processor accumulates and processes more laser pulses per unit time compared to if the first condition is met.

12. A method for operating a LiDAR device comprising:
an optical transmitter for transmitting a laser pulse for detection of an external object,
an optical receiver for receiving the laser pulse reflected by the external object, and
a controller for controlling the optical transmitter and the optical receiver,
the method comprising:
determining, with the controller, whether a first condition or a second condition is met;
if the controller determines that the first condition is met, transmitting, with the optical transmitter, a duty cycle of the laser pulse at a first duty cycle under control of the controller; and
if the controller determines that the second condition is met, increasing, with the optical transmitter, the duty cycle of the laser pulse to a second duty cycle greater than the first duty cycle under the control of the controller and transmitting at the second duty cycle.

13. The method of claim 12, wherein the LiDAR device is installed in a vehicle; and
the first condition is that a speed of the vehicle is less than a reference speed, and
the second condition is that a speed of the vehicle is equal to or greater than the reference speed.

14. The method of claim 12, wherein the first condition is that a temperature is equal to or greater than a reference temperature, and
the second condition is that a temperature is less than the reference temperature.

15. The method of claim 12, wherein a period of the second duty cycle is set to be shorter than a period of the first duty cycle.

16. The method of claim 12, wherein a pulse width of the first duty cycle and a pulse width of the second duty cycle are the same, and
a period of the second duty cycle is set to be shorter than a period of the first duty cycle.

17. The method of claim 12, wherein a pulse width of the first duty cycle and a pulse width of the second duty cycle are different, and
a period of the second duty cycle is set to be shorter than a period of the first duty cycle.

18. The method of claim 12, wherein the LiDAR device further comprises a signal processor for processing the laser pulse received by the optical receiver under the control of the controller, and
the method further comprising:
accumulating and processing, with the signal processor, the received laser pulse for a unit time set identically regardless of the first condition and the second condition.

19. The method of claim 18, if the second condition is met, the signal processor accumulates and processes more laser pulses per unit time compared to if the first condition is met.

20. A non-transitory computer-readable storage medium having a program stored thereon including at least one instruction for performing the method for operating the LiDAR device of claim 12.
